(19) United States
(12) Patent Application Publication
(10) Pub. No.: US 2015/0371454 A1
(43) Pub. Date: Dec. 24, 2015

(54) System and Method for Severity Characterization of Machine Events

(71) Applicant: Caterpillar Inc., Peoria, IL (US)

(72) Inventors: Benjamin J. Hodel, Dunlap, IL (US); Michael JC Smith, Forsyth, IL (US)

(21) Appl. No.: 14/309,228

(22) Filed: Jun. 19, 2014

(51) Int. Cl. G07C 3/00; G07C 5/00; G01M 13/00; G01M 1/12; G01P 15/00

(52) U.S. Cl. CPC G07C 3/00; G01M 1/122; G01P 15/00; G01M 13/00; G07C 5/00

(57) ABSTRACT

A method for severity characterization of machine events is provided. The method includes receiving, at a processor, a plurality of inputs corresponding to measurements from a plurality of accelerometers placed on a machine component based upon a geometry of the machine component. The method includes determining a displacement time series based upon the plurality of inputs. The method includes comparing the displacement time series with coordinate locations of a plurality of corners of the machine component. The method includes characterizing severity of a machine event for the machine component, based upon said comparing.

### TECHNICAL FIELD

This patent disclosure relates generally to quantification and detection of severity events in machines, and more particularly, to a system and method for severity characterization of machine events.

### BACKGROUND

Machines undergo harsh treatment on rough terrain. Such harsh treatment may be characterized by detecting and quantifying severity of machine events. Conventionally, loads and strains on machines and/or machine components are measured from a highly instrumented machine using load transducers and strain gages. However, such load transducers and strain gages are expensive and tend to break over time.

One conventional approach includes using a dense network of sensors placed all over the machine or a machine component. This conventional approach relies upon the fact that the more the number of sensors, the more accurate is the severity characterization. However, excessive usage of sensors also increases costs and is not an optimal solution.

One conventional approach uses accelerometers that are more robust and are becoming increasingly cheaper, but has difficulty separating large, non-damaging rigid body translations and rotations from severe, damage-inducing shocks. For example, U.S. Pat. No. 7,822,560 discloses three orthogonally placed accelerometers on a wind turbine. However, use of three accelerometers does not fully describe various deformation modes such as frame racking (twisting or warping), frame shearing (skewing), frame bending (curvature), and ride quality (jerk).

One conventional approach uses single accelerometers in combination with other sensors to produce a radar chart. When the combinations of values on the chart have higher values, then such higher values are interpreted as “high severity.” Other data analysis software take acceleration data and use spectral processing methods to produce “Operational Deflection Shapes” (ODS). These ODS results are calculated primarily to analyze high-frequency vibration, but not low-frequency impact deformations.

Another conventional approach looks at signals that correlate to ground-engaging damage at larger timescales, such as fuel burned over time or cylinder work. However, this approach has trouble identifying impact shocks such as swing loads, corner loads, oscillation holes and pot hole events.

Accordingly, there is a need to resolve these and other problems related to accurate detection and/or characterization of severity events in machines.

### SUMMARY

In one aspect, a method for severity characterization of machine events is provided. The method includes receiving, at a processor, a plurality of inputs corresponding to measurements from a plurality of accelerometers placed on a machine component based upon a geometry of the machine component. The method includes determining a displacement time series based upon the plurality of inputs. The method includes comparing the displacement time series with coordinate locations of a plurality of corners of the machine component. The method includes characterizing severity of a machine event for the machine component, based upon said comparing.

In another aspect, a system for severity characterization of machine events is provided. The system includes a plurality of accelerometers on a machine, said plurality of accelerometers being placed on a machine component based upon a geometry of the machine component. The system includes a processor operatively coupled to the plurality of accelerometers and configured to obtain measurements from the plurality of accelerometers, and characterize severity of a machine event based upon the obtained measurements.

In yet another aspect, a computer readable medium storing computer executable instructions thereupon for severity characterization of machine events is provided. The instructions when executed by a processor cause the processor to receive a plurality of inputs corresponding to measurements from a plurality of accelerometers placed on a machine component, determine a displacement time series based upon the plurality of inputs, compare the displacement time series with coordinate locations of a plurality of corners of the machine component, and characterize severity of a machine event for the machine component, based upon the comparing.

### BRIEF DESCRIPTION OF THE DRAWINGS

FIG. 1 illustrates a system for severity characterization of machine events, in accordance with an aspect of this disclosure.

FIG. 2 illustrates a method for severity characterization of machine events, in accordance with an aspect of this disclosure.

FIGS. 3 and 4 illustrate warpage computation for a machine component, in accordance with an aspect of the disclosure.

FIG. 5 illustrates setting up of an inertial frame of reference and a body frame of reference, in accordance with an aspect of the disclosure.

FIG. 6 illustrates position vectors, in accordance with an aspect of the disclosure.

FIG. 7 illustrates skew computation for a quadrangle associated with a machine component, in accordance with an aspect of the disclosure.

FIG. 8 illustrates skew computation for a triangle associated with a machine component, in accordance with an aspect of the disclosure.

FIG. 9 illustrates a bending computation for a machine component, in accordance with an aspect of the disclosure.

FIG. 10 illustrates a flowchart for a jerk calculation for a machine component, in accordance with an aspect of the disclosure.

### DETAILED DESCRIPTION

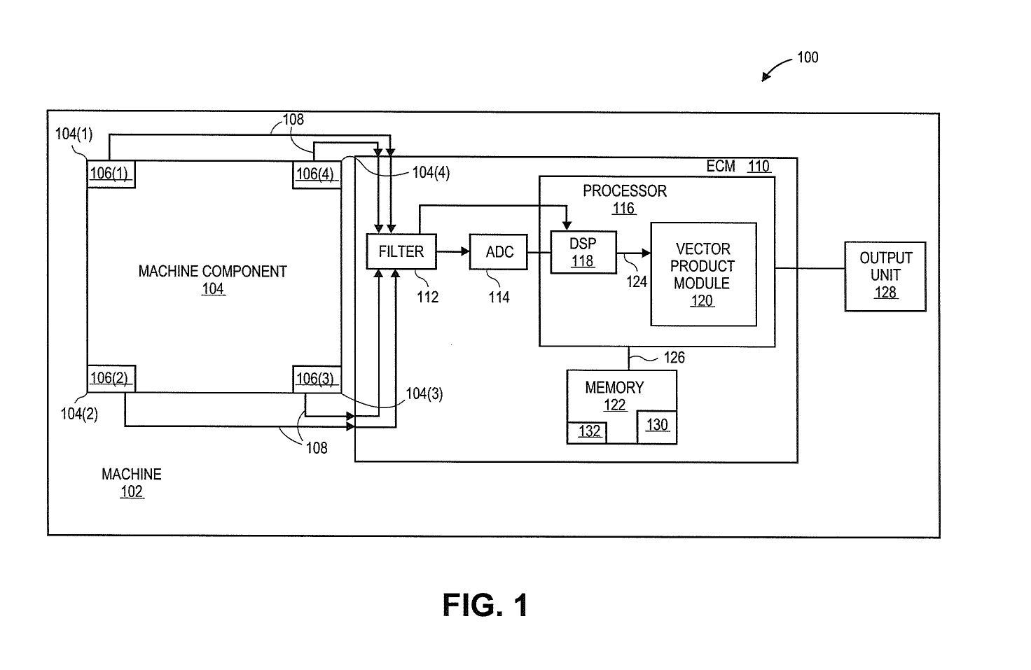

Now referring to the drawings, wherein like reference numbers refer to like elements, there is illustrated in FIG. 1 an exemplary aspect of a system 100 for severity characterization of machine events, in accordance with an aspect of this disclosure. The system 100 includes a machine 102, although the system 100 may include additional components such as base stations, communication systems, antennas, satellite systems, etc. The machine 102 may be a mobile or a stationary machine that performs operations associated with industries such as mining, automotive, aerospace, naval, power generation, clean energy, construction, farming, transportation, landscaping, or the like. For example, the machine 102 may be a medium wheel loader, a large wheel loader, a medium track-type tractor, a large track-type tractor, an off-highway truck, a large mining truck, a wheel tractor scraper, a motor grader, an articulated truck, a hydraulic excavator, an electric rope shovel, a dragline, an industrial/waste machine, a vehicle, an earth-moving machine, a wind turbine, an airplane engine, a ship, a submarine, a space craft, a bridge or a civil structure, or subcomponents thereof. In use, the machine 102 and/or a part thereof may undergo one or more severity events including but not limited to large structure deformations, as well as small structure deformations, depending upon an environment in which the machine 102 is used. While the following detailed description describes an exemplary aspect in connection with the machine 102 having certain components or implements, it should be appreciated that the description applies equally to the use of the present disclosure in other machines having other types of components or implements. Further, the system 100 may include any number of machines and FIG. 1 illustrates only one machine 102 by way of example only and not by way of limitation.

The machine 102 includes a machine component 104, a plurality of accelerometers 106(1)-106(4) placed on a plurality of corners 104(1)-104(4), respectively, of the machine component 104, an electronic control module (ECM) 110, and an output unit 128. In one aspect, the output unit 128 may be optional or may be located outside the machine 102. The machine 102 may have additional components (not shown), including but not limited to, trusses, frames, blades, a front frame and a rear frame, coupled together via an articulated hitch, a non-articulated mainframe (in the alternative), pair of articulated front wheels, a pair of tandem rear wheels, a single pair of rear wheels (in the alternative), a pair of track assemblies, a seat or operator cab, one or more windows, an engine compartment, one or more joysticks, control pods, foot pedals, operator displays in the operator cab, engine compartment housing an engine system, including an engine, an intake system, an exhaust system and an engine control system, as well as other engine support systems, such as, for example, a fuel system, a cooling system, a lubrication system, etc.

By way of example only and not by way of limitation, the machine component 104 may be a chassis of an engine, an axle, a frame and/or a body of the machine 102, a drill, a blade, a wing, a suspension, or any other type of machine component that may suffer from deformation, damage, or a machine event whose severity may be determined and characterized in accordance with various aspects of this disclosure. The term “characterization” may be associated with establishing standards or standard parameters that qualitatively and/or quantitatively describe the severity of a machine event. The machine component 104 may be a component associated with a flexbody system for which continuous or on-going monitoring of large structural deformations may be useful. The machine component 104 may include a frame at its extremity, which may be used to attach or place the plurality of accelerometers 106(1)-106(4). In one aspect, the machine component 104 may be of a specific geometry. By way of example only, the machine component 104 in FIG. 1 is of a rectangular geometry. However, the machine component 104 may be of any other geometry including but not limited to a polygonal geometry with three or more sides (a triangle, a square, a pentagon, etc.), a circular geometry, or any other type of symmetric or asymmetric geometry. The machine component 104 may be one dimensional, two dimensional, or three dimensional. The machine component 104 may be visible to an observer outside the machine 102 or may be invisible or hidden to the observer outside the machine 102. The machine component 104 may be deformed, damaged, or otherwise be directly or indirectly impacted by various machine events, e.g., sudden jerks or impact shocks such as swing loads, corner loads, oscillation holes, and pot hole events, bumps due to an uneven terrain on which the machine 102 is moving, wind gusts, severe weather conditions, accidents, earthquakes, or any other type impulsive force generating event. In one aspect, the machine component 104 may be deformed or damaged simply as a result of usage over time.

The plurality of accelerometers 106(1)-106(4) may be tri-axial accelerometers placed at each of the corners 104(1)-104(4), respectively, of the machine component 104. Such tri-axial accelerometers may provide electrical signal outputs (e.g., voltages) corresponding to three axes of a coordinate system (e.g., a Cartesian coordinate system). The plurality of accelerometers 106(1)-106(4) form a network of accelerometers configured to simultaneously and synchronously measure accelerations of the area around the plurality of corners 104(1)-104(4). The corners 104(1)-104(4) form the nodes of the network of accelerometers formed by the plurality of accelerometers 106(1)-106(4). It is to be noted that although four accelerometers 106(1)-106(4) are being discussed, higher number of accelerometers may be used depending upon the geometry of the machine component 104.

Likewise, a lower number of accelerometers, e.g., three accelerometers could be used for a triangular geometry of the machine component 104. The specific number of accelerometers (e.g., four in FIG. 1) is chosen as an optimal number such that low frequency impact deformations of the machine component 104 (e.g., warpage, shearing, bending, jerk, etc.), are accurately determined without having an excessive or overwhelming number of sensors or accelerometers. For example, in FIG. 1, although more than four, e.g., five, accelerometers may be used, this would result in additional costs as five accelerometers on a rectangular or a square shape of the machine component 104 would provide redundant information. By way of example only and not by way of limitation, the plurality of accelerometers 106(1)-106(4) may be potentiometric, piezoelectric, capacitive (micro electro-mechanical systems (MEMS) type), and the like, or combinations thereof. Each of the plurality of accelerometers 106(1)-106(4) is coupled to the ECM 110 by connections 108 on which voltages corresponding to measurements made by the plurality of accelerometers 106(1)-106(4) are carried. The connections 108 may be wired or wireless. In one aspect, the plurality of accelerometers 106(1)-106(4) may be removably attached to the machine 102 and/or the machine component 104. For example, the plurality of accelerometers 106(1)-106(4) may be glued to the machine 102 and/or the machine component 104, and subsequently removed after the measurements have been performed. The plurality of accelerometers 106(1)-106(4) may then be used on other machines or machine components.

When the plurality of accelerometers 106(1)-106(4) are tri-axial accelerometers, each of the plurality of accelerometers 106(1)-106(4) measures acceleration along three axes and provides three corresponding voltage readings. As a result, at a given moment in time, twelve voltage readings are provided to the ECM 110 by the plurality of accelerometers 106(1)-106(4). In one aspect, when the machine component 104 has an asymmetric shape, the plurality of accelerometers 106(1)-106(4) may be placed strategically at nodes or points on the machine component 104 that are known to have or expected to have deformations or damages. Alternatively, such nodes or points where the plurality of accelerometers 106(1)-106(4) may be placed may be chosen randomly (e.g., during a test phase of the system 100). In one aspect, the plurality of accelerometers 106(1)-106(4) may be used in conjunction with a plurality of gyroscopes (not shown) placed on the machine 102 and/or the machine component 104 to yield rotational accelerations or deflections. For example, such gyroscopes may be placed toward a front axle (not shown) of the machine 102 where an impact may occur and about which the machine 102 and/or the machine 104 may pivot.

The ECM 110 includes a filter 112, an analog to digital converter (ADC) 114, a processor 116, and a memory 122. The ECM 110 may include additional components including but not limited to input-output interfaces to receive the signals carried by the connections 108, power supplies, heat sinks, buses, antennas, transceivers, amplifiers, electromagnetic interference protection circuitry, displays, digital to analog converters (DACs), status indicator diodes, clocking circuitry, oscillators, backup processors and/or co-processors, signal conditioning circuitry, solenoid driver circuitry, analog circuits, communication chips (e.g., CAN chips, GPS chips, etc.), phase locked loops (PLLs), programmable logic arrays (PLAs), application specific integrated circuits (ASICs), field programmable gate arrays (FPGAs), and/or other electronic components. In one aspect, the filter 112, the ADC 114, the processor 116, the memory 122 may reside on a single layer or a multi-layer printed circuit board (PCB) included within the ECM 110. The ECM 110 may be configured to carry out other functions and features in addition to or other than those provided in various aspects of this disclosure, e.g., providing signals to control an engine of the machine 102. Further, the ECM 110 may be encapsulated in a protective cover and may be removably attached to the machine 102. Alternatively, the ECM 110 may be a permanent installation as part of the machine 102 during production or assembly of the machine 102. Furthermore, although only one ECM 110 is illustrated in FIG. 1, one of ordinary skill in the art will understand upon reading this disclosure that additional ECMs may be provided on the machine 102. In one aspect, the ECM 110 may be physically separate from the machine 102. For example, the processing of measurements from the plurality of accelerometers 106(1)-106(4) may be carried out on a computer (e.g., a personal computer, mobile device, in the “cloud”, etc.) and such processing may not necessarily be carried out on the ECM 110. In another aspect, measurement signals carried by the connections 108 may be analog filtered by the filter 112, digitally acquired, sent off the machine 102, and then the DSP 118 and vector product module 120 may be configured to carry out one or more calculations associated with the measurements from the plurality of accelerometers 106(1)-106(4) off-board or away from the machine 102.

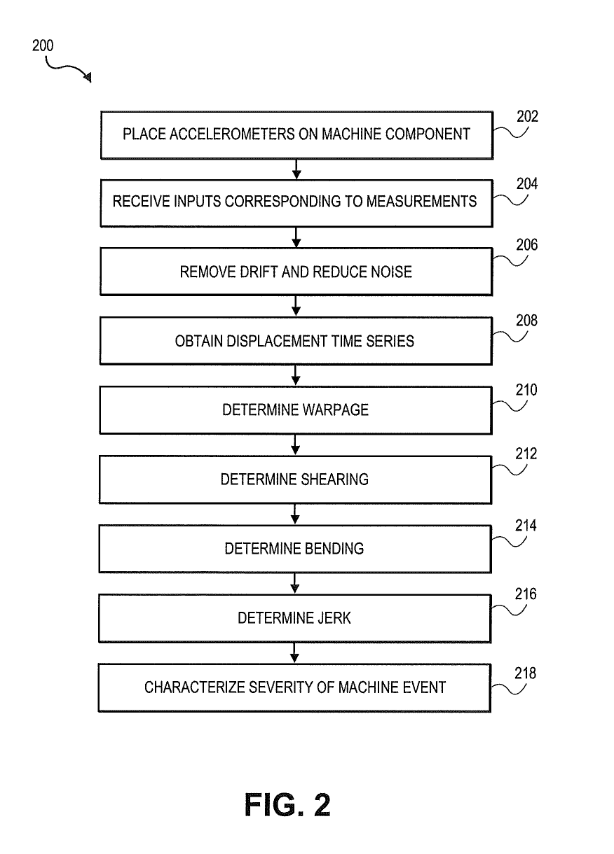

The ECM 110 receives analog voltage signals as a function of time from the plurality of accelerometers 106(1)-106(4) at the filter 112. In this sense, the filter 112 may be an analog filter. In one aspect, the filter 112 is configured to prevent aliasing as the signals are converted from analog to digital, e.g., by the ADC 114. Such signals may be received at an input/output port (I/O port) of the ECM 110. The filter 112 may be a combination of plurality of filters (a filter bank) including a high pass filter and a low pass filter. For example, the filter 112 may be designed as a Butterworth, Chebyshev, or other ordered polynomial filter. In one aspect, the filter 112 is designed to smooth out noise from the analog signals received over the connections 108. The filter 112 may be designed to remove drift, as discussed with respect to FIG. 2. In another aspect, the filter 112 may be a Kalman filter. In various implementations, the filter 112 may be integrated with the processor 116, in which case the processor 116 is configured to receive the measurements from the plurality of accelerometers 106(1)-106(4) as plurality of inputs. An output of the filter 112 is provided as an input to the processor 116 and/or to the ADC 114.

The ADC 114 may be an n-bit ADC, where the index ‘n’ is an integer. In one aspect, the ADC 114 is coupled to the filter 112 to receive a plurality of inputs representative of measurements made by the plurality of accelerometers 106(1)-106(4). For example, the ADC 114 includes twelve input lines to receive the voltage signals outputted by the plurality of accelerometers 106(1)-106(4). The ADC 114 is coupled to the processor 116 at an output. The ADC 114 is configured to provide digital output equivalent of the measurements made by plurality of accelerometers 106(1)-106(4) to the processor 116.

The processor 116 may include a digital signal processing (DSP) module 118 and a vector product module 120. The DSP module 118 is coupled to the vector product module 120 over a bus 124 configured to carry a signal representing a displacement time series, as discussed with respect to FIG. 2. The processor 116 of the ECM 110 may be an n-bit microprocessor, where ‘n’ is an integer (e.g., n=16, 32, etc.) operating at a particular clock frequency (e.g., 40 MHz). The processor 116 is coupled to the memory 122 via a connection 126. In one aspect, the processor 116 may be a general purpose processing unit. The processor 116 may be configured, adapted, or programmed to receive and process instructions 130 from the memory 122 at one of input lines or pins of the processor 116 coupling to the connection 126. In addition, processor 116 may be configured, adapted, or programmed to carry out additional steps. The processor 116 may execute one or more of the instructions 130 and obtain known coordinate locations 132 of the plurality of corners 104(1)-104(4) stored in memory 122, which cause it to carry out or perform various features and functionalities of the aspects of this disclosure, e.g., as discussed with respect to FIG. 2. By way of example only and not by way of limitation, the coordinate locations 132 stored in the memory 122 may be in Cartesian format (X, Y, Z), although other coordinate systems could be used. Further by way of example only and not by way of limitation, the instructions 130 may be computer executable instructions in assembly or other low level language that may be processed by the processor 116. Alternatively or additionally, the instructions 130 may be in high level code, e.g., in the C programming language having an appropriate compiler. In one aspect, the processor 116 may include additional components such as a co-processor (not shown) and/or additional circuitry.

The DSP module 118 is configured to perform digital signal processing and computations associated with the plurality of inputs from the ADC 114. Such computations, e.g., double integration, carried out by the DSP module 118 are discussed with respect to FIGS. 2-10. Further, the DSP module 118 may be configured to reduce noise and remove drift from the digital samples received from the ADC 114. In one aspect, the DSP module 118 may be a standalone integrated circuit (IC) chip by itself that is packaged within the processor 116.

Likewise, the vector product module 120 is configured to compute cross products and dot products of the various vectors inferred from or provided as part of the measurements from the plurality of accelerometers 106(1)-106(4). In one aspect, the vector product module 120 may be a standalone integrated circuit (IC) chip by itself that is packaged within the ECM 110.

The memory 122 is connected to the processor 116 by the connection 126 and stores computer readable and computer executable instruction sets, fuel maps, lookup tables, variables, and the like. In one aspect, the memory 122 stores the instructions 130 and the coordinate data obtained from the coordinate locations 132 of the plurality of corners 104(1)-104(4), which correspond to a plurality of nodes of a network formed by the plurality of accelerometers 106(1)-106(4). In one aspect, the memory 122 may be an electrically erasable programmable read-only memory (EEPROM), although other memory types could be used (e.g., random access memory (RAM) units). In another aspect, the memory 122 includes computer executable instructions 130 thereupon, which when executed by the processor 116 cause the processor 116 to carry out the various features and functionalities of the present disclosure, e.g., one or more operations discussed with respect to FIGS. 2-10.

In one aspect, the ECM 110 is coupled to the output unit 128. The output unit 128 may include a display, an external storage medium, and/or a graphics processor to visually present time evolving characterization of severity of a machine event, based upon the processing carried out by the processor 116. In one aspect, the output unit 128 may be remote from the ECM 110 and/or the machine 102. For example, the output unit 128 may be part of a display at a base station (not shown) or a remote computing device (e.g., a hand held tablet device with display). The output unit 128 may be configured to wirelessly receive severity characterization data of the machine event as captured by the plurality of accelerometers 106(1)-106(4) for analysis and design of future machines.

### INDUSTRIAL APPLICABILITY

An aspect of the present disclosure is applicable generally to quantification and detection of severity events in machines, and more particularly, to a system and method for severity characterization of machine events. Some conventional techniques for severity characterization overload the machine with multitudes of sensors and gages that increase costs and are more prone to damage. Such conventional techniques face problems in separating large, non-damaging rigid body translations and rotations from severe, damage-inducing shocks. The data processing associated with the conventional techniques calculates high-frequency vibration, but not low-frequency impact deformations. Yet other conventional techniques provide only a one-accelerometer view to potential ground-induced damage using relative damage spectrum (RDS) or fatigue damage spectrum (FDS). The aspects of the present disclosure overcome these drawbacks.

FIG. 2 presents a flowchart of a process or a method 200 for severity characterization of machine events, in accordance with an aspect of this disclosure. One or more processes of the method 200 of may be skipped or combined as a single process, repeated several times, and the flow of operations in the method 200 may be in any order not limited by the specific order illustrated in FIG. 2. For example, various operations may be moved around in terms of their respective orders, or may be carried out in parallel with one or more other operations. Further, the functioning or functionalities of the system 100 are not affected by an order in which the aspects discussed in FIGS. 2-10 are implemented, and such an order of implementation is by way of example only and not by way of limitation.

The method 200 may begin in an operation 202 where the plurality of accelerometers 106(1)-106(4) are placed on the machine component 104 and/or the machine 102. In one aspect, the plurality of accelerometers 106(1)-106(4) may include exactly four accelerometers 106(1)-106(4). The accelerometers 106(1)-106(4) may be placed strategically at the four corners 104(1)-104(4) of the machine component 104 to align with a rectangular or a square geometry of the machine component 104. In one aspect, the plurality of accelerometers 106(1)-106(4) may be placed on different parts of the machine 102, e.g., on a body of the machine 102. As discussed, more than four accelerometers may be used depending upon a geometry of the machine 102 and/or the machine component 104. For example, when the machine component 104 is pentagonal in shape, five accelerometers may be used, and the discussion with respect to four of the plurality of accelerometers 106(1)-106(4) in this disclosure is by way of example only and not by way of limitation. Likewise, the plurality of accelerometers 106(1)-106(4) may be placed symmetrically or asymmetrically on the machine component 104 and/or the machine 102. In one aspect, the plurality of accelerometers 106(1)-106(4) may be placed on parts of the machine component 104 and/or the machine 102 with a history of experiencing machine events. For example, certain parts of the machine component 104 and/or the machine 102 may experience more damage than the others due to their orientation, shape, and/or the way in which those parts may be used during the operation of the machine 102 and/or the machine component 104. The plurality of accelerometers 106(1)-106(4) may then be placed accordingly at such known parts of the machine component 104 and/or the machine 102 that are more prone than others to experience machine events. The plurality of accelerometers 106(1)-106(4) may be placed to form a plurality of nodes of a network from a data processing perspective. For example, the plurality of accelerometers 106(1)-106(4) and the measurements originating therefrom may be graphically presented on the output unit 128 as a time evolving graph with each of the plurality of accelerometers 106(1)-106(4) being a node on the graph. The placing of the plurality of accelerometers 106(1)-106(4) may be carried out manually or by using robotic implements controlled, for example, by the processor 116. In yet another aspect, the plurality of accelerometers 106(1)-106(4) may be placed in a manner such that some of the plurality of accelerometers 106(1)-106(4), e.g., the accelerometers 106(1) and 106(2) may be on the machine component 104, whereas the remaining accelerometers, e.g., the accelerometers 106(3) and 106(4), may be placed on parts of the machine 102 that are physically separate from the machine component 104. Furthermore, the plurality of accelerometers 106(1)-106(4) may be positioned on the machine 102 as groups, e.g., groups of four accelerometers, on various machine components other than the machine component 104. For example, the plurality of accelerometers 106(1)-106(4) may be placed on four different wheels of the machine 102. The plurality of accelerometers 106(1)-106(4) may be powered by a battery or other power sources (not shown) on the machine 102. In one aspect, the plurality of accelerometers 106(1)-106(4) may be placed during production or assembly of the machine 102 and/or the machine component 104. Alternatively, the plurality of accelerometers 106(1)-106(4) may be placed such that after use, the plurality of accelerometers 106(1)-106(4) may be removed from the machine 102 and/or the machine component 104.

In an operation 204, the processor 116 may receive inputs corresponding to measurements from the plurality of accelerometers 106(1)-106(4). In one aspect, the measurements may be output as voltage signals from each of the plurality of accelerometers 106(1)-106(4) on the connections 108 (wired or wirelessly). In one aspect, the processor 116 may receive the inputs from the plurality of accelerometers 106(1)-106(4) synchronously or simultaneously. Alternatively, the processor 116 may receive the inputs from the plurality of accelerometers 106(1)-106(4) asynchronously. For example, the measurements made by the plurality of accelerometers 106(1)-106(4) may be stored in a memory device, e.g., the memory 122, as a function of time, and made available to the processor 116 at a later point in time. In one aspect, prior to receiving the inputs from the plurality of accelerometers 106(1)-106(4), the processor 116 may establish and test the communication channel formed by the connections 108, for example, to carry out authentication and protocol compliance issues related to communication with the plurality of accelerometers 106(1)-106(4). Further, the processor 116 may directly receive the measurements from the plurality of accelerometers 106(1)-106(4), or may receive the measurements indirectly. For example, the measurements from the plurality of accelerometers 106(1)-106(4) may be provided to the ECM 110, e.g., to the filter 112 of the ECM 110, and the processor 116 may subsequently receive the measurements as a transformed signal processed by the filter 112 and/or the ADC 114, or other circuitry.

In an operation 206, the ECM 110 may remove drift and reduce noise from the inputs received in the operation 204. For example, the filter 112 may be used to remove the drift and reduce the noise to provide a cleaner signal corresponding to the measurements made by the plurality of accelerometers 106(1)-106(4) to the ADC 114. In one aspect, the processor 116 may directly receive the inputs, as discussed with respect to the operation 204, and may carry out drift removal and noise reduction prior to processing the received inputs. For example, the DSP module 118 may smooth noise and remove drift from the discrete samples received from the output of the ADC 114. Various Kalman filtering algorithms may be implemented in the DSP module 118 to perform drift removal, noise reduction and/or noise removal. By way of example only and not by way of limitation, drift removal may be carried out using standard numerical methods involving window mean subtraction, polynomial fit and removal, high-pass filtering including finite impulse response (FIR) or infinite impulse response (IIR) schema, and the like, or combinations thereof.

In an operation 208, the ADC 114 provides a digital signal corresponding to the measurements made by the plurality of accelerometers 106(1)-106(4) to the DSP module 118 of the processor 116. The DSP module 118 may process the digital signal to output a displacement time series corresponding to the acceleration measurements from the plurality of accelerometers 106(1)-106(4). The displacement time series may be output by the DSP module 118 based upon a double integration carried out by the DSP module 118 to obtain displacement from acceleration. Standard numerical methods may be used by the DSP module 118 to calculate such a double integral. For example, for a given time instance, a twelve point series corresponding to measurements made by four tri-axial accelerometers (i.e., four times three, or twelve measurements) may be obtained. In one aspect, the results of such a double integration may be stored in the memory 122. Intermediate results, such as a velocity or speed time series may be obtained by a single integration of the acceleration measurements, and also be stored in the memory 122. In another aspect, the DSP module 118 may not calculate the double integral of the accelerations, but treat them as a simple harmonic motion of a spring-mass plate system of modal vibrations, in which case the DSP module 118 may multiply node accelerations received from the plurality of accelerometers 106(1)-106(4) by a matrix to get displacement of the plurality of corners 104(1)-104(4) without integrating.

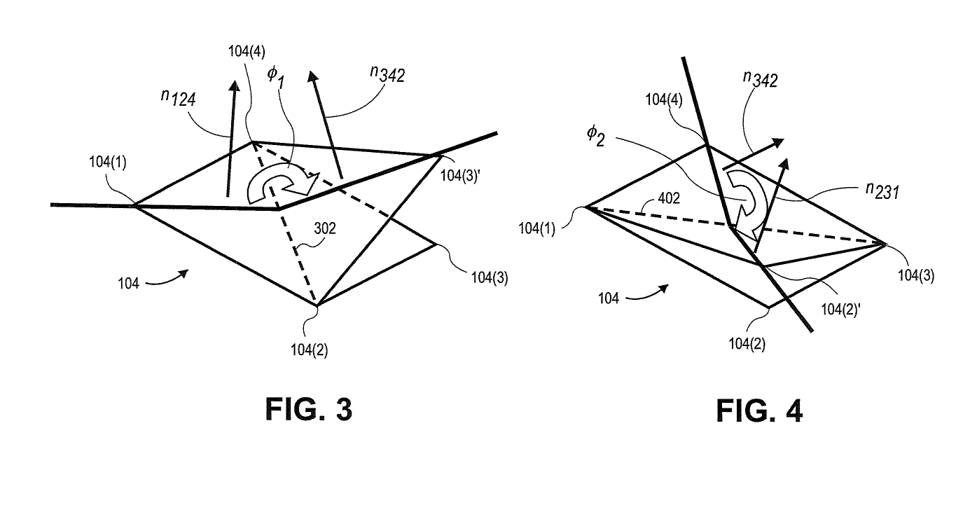

In an operation 210, the displacement time series may be provided to the vector product module 120. The vector product module 120 may compute various cross and dot products on the displacement time series. In one aspect, using the cross and the dot products calculated by the vector product module 120, the processor 116 may compute a warpage or racking associated with the machine 102 and/or the machine component 104. One or more outputs of the vector product module 120 may determine the warpage, as discussed with respect to FIGS. 3-6. In another aspect, the vector product module 120 may be configured to transform the plurality of displacement measures obtained from the measurements from the plurality of accelerometers 106(1)-106(4) into single geometric deformation angle measures. It is to be noted that in some aspects of this disclosure, although the discussion may relate to the machine component 104, the discussion is equally applicable to the machine 102 or other parts of the machine 102 for which a severity characterization may need to be carried out, in accordance with various aspects of this disclosure. FIGS. 3 and 4 illustrate warpage along different axes encountered by the machine component 104.

FIG. 3 illustrates the four corners 104(1)-104(4) of the machine component 104 with the position of the corner 104(3) being displaced to a new position 104(3)′. The machine component 104 may warp, for example, along a line 302 joining the opposite corners 104(2) and 104(4). The processor 116 may calculate a first normal n₁₂₄ for the plane formed by the corners 104(1), 104(2), and 104(4) based upon the measurements received from the respective accelerometers 106(1), 106(2), and 106(4), respectively. Similarly, the processor 116 may calculate a second normal n₃₄₂ for the plane formed by the corners 104(3), 104(4), and 104(2) based upon the measurements received from the respective accelerometers 106(3), 106(4), and 106(2), respectively. The warpage calculation by the processor 116 may include a first warpage angle φ₁ by which a plane of the machine component 104 warps along the line 302. The first warpage angle φ₁ may be an angle between the first normal n₁₂₄ and the second normal n₃₄₂.

Likewise, FIG. 4 illustrates the four corners 104(1)-104(4) with the position of the corner 104(2) being displaced to a new position 104(2)′. The machine component 104 may warp, for example, along a line 402 joining the opposite corners 104(1) and 104(3). The processor 116 may calculate a third normal n₄₁₃ for the plane formed by the corners 104(4), 104(1), and 104(3) based upon the measurements received from the respective accelerometers 106(4), 106(1), and 106(3), respectively. Similarly, the processor 116 may calculate a fourth normal n₂₃₁ for the plane formed by the corners 104(2), 104(3), and 104(1) based upon the measurements received from the respective accelerometers 106(2), 106(3), and 106(1), respectively. The warpage calculation by the processor 116 may include a second warpage angle φ₂ by which a plane of the machine component 104 warps along the line 402. The second warpage angle φ₂ may be an angle between the third normal n₄₁₃ and the fourth normal n₂₃₁.

As discussed, each of the plurality of accelerometers 106(1)-106(4) outputs a respective measurement. By way of example only, when there are exactly four accelerometers 106(1)-106(4), a set of such measurements at a given point in time is referred to as a quadrangle. Warpage in two-dimensional elements (e.g., one or more planes of the machine component 104) may be calculated by splitting a quadrangle into two triangles and finding an angle (e.g., the first angle φ₁) between the two planes which the triangles form. The quadrangle can then be split again using the opposite corners and forming another set of triangles and another angle (e.g., the second angle φ₂) may be determined by the processor 116. For example, in FIGS. 3 and 4, a first set of triangles may correspond to the planes formed by the corners 104(1), 104(2), and 104(4), the corners 104(3), 104(4), and 104(2), and a second set of triangles may correspond to the planes formed by the corners 104(1), 104(4), and 104(3), and the corners 104(2), 104(3), and 104(1). The angles φ₁ and φ₂ between the two planes which the two sets of triangles form is then calculated by the processor 116. The maximum angle between the planes is the warpage of the quadrangle element formed by the plurality of corners 104(1)-104(4). Likewise, for a pentagonal geometry of the machine 102 and/or the machine component 104, sets of planes formed by four corners and the angles between them may be computed. The maximum angle may then be determined by the processor 116 to indicate a warpage of the machine 102 and/or the machine component 104.

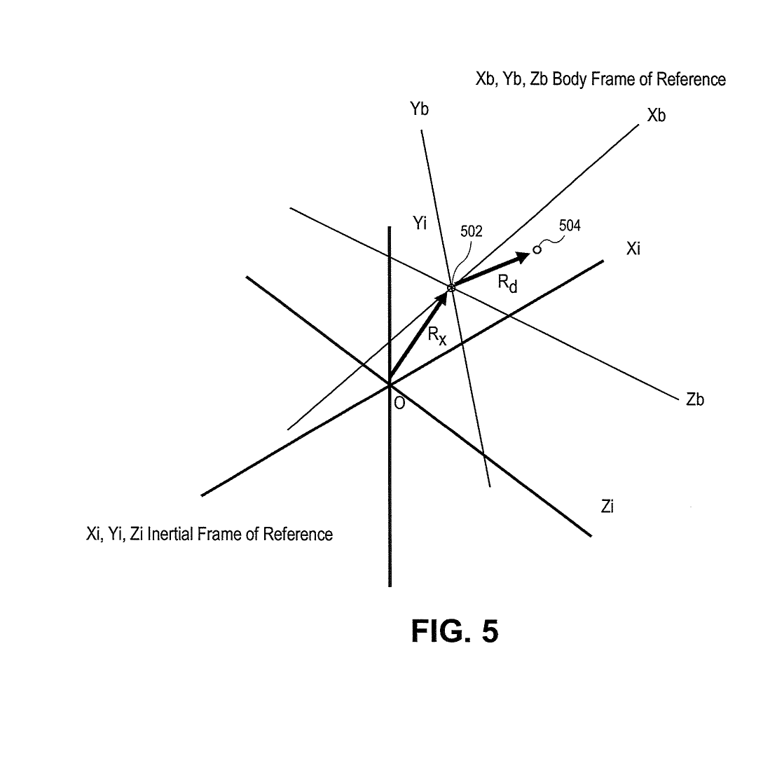

Referring to FIG. 5, the processor 116 may initially define frames of reference for calculating the first normal n₁₂₄, the second normal n₃₄₂, the third normal n₄₁₃ and the fourth normal n₂₃₁, the first angle φ₁ and the second angle φ₂, and the subsequent warpage. The processor 116 may carry out a calculation of position vectors Rₓ and R_{d} for the machine component 104. The position vector Rₓ is measured from an origin O of an inertial frame of reference (denoted by axes Xᵢ, Yᵢ, and Z₁, where the subscript ‘i’ denotes the inertial frame of reference) and corresponds to a reference point 502. The position vector R_{d} is measured relative to the reference point 502 for a point 504 on a body the machine component 104 and/or the machine 102. The reference point 502 may be an origin for a body frame of reference (denoted by axes X_{b}, Y_{b}, and Z_{b}, where the subscript ‘b’ denotes the body frame of reference).

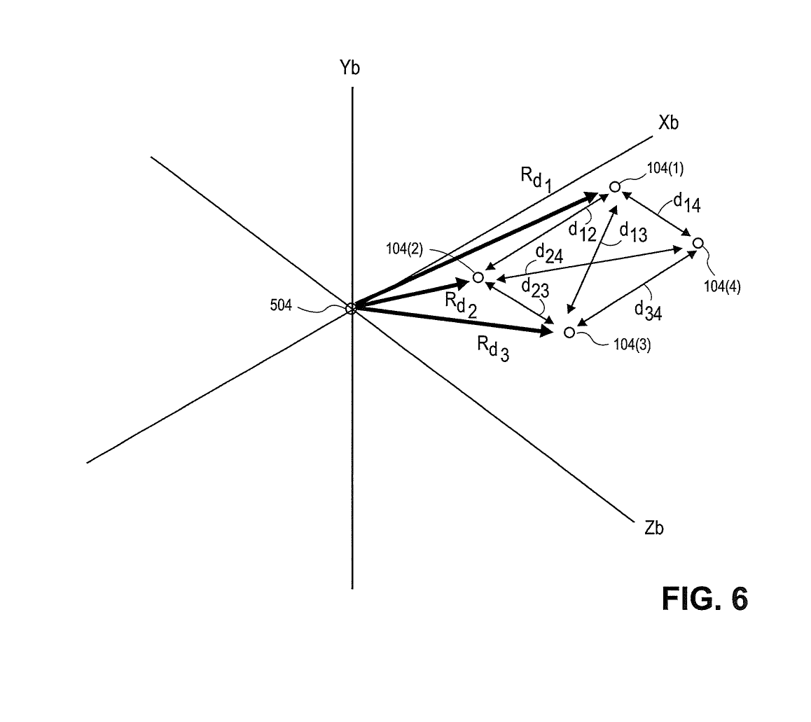

With the inertial and the body reference frames generally defined as an example in FIG. 5, FIG. 6 illustrates a determination of relative distances (dᵢⱼ, i, j=1, 2, 3, 4) between the four corners 104(1)-104(4) based upon the point 504 on the body of the machine 102 and/or machine component 104. The relative distances may then be used by the processor 116 for computations related to the relative distances dᵢⱼ from the displacement time series samples for calculating the warpage. For example, the processor 116 may determine a plurality of position vectors d₁₂, d₁₃, d₁₄, d₂₃, d₂₄, and d₃₄ defined by a set of eqs. (1) as:

$${\vec{d}}_{12} = \begin{matrix}( \begin{matrix}{d}_{2 {x}_{0}} + Δ {d}_{2 x} & {d}_{2 {y}_{0}} + Δ {d}_{2 y} & {d}_{2 {z}_{0}} + Δ {d}_{2 z}\end{matrix} ) & -\end{matrix} ( \begin{matrix}{d}_{1 {x}_{0}} + Δ {d}_{1 x} & {d}_{1 {y}_{0}} + Δ {d}_{1 y} & {d}_{1 {z}_{0}} + Δ {d}_{1 z}\end{matrix} ) \\ {\vec{d}}_{13} = ( \begin{matrix}{d}_{3 {x}_{0}} + Δ {d}_{3 x} & {d}_{3 {y}_{0}} + Δ {d}_{3 y} & {d}_{3 {z}_{0}} + Δ {d}_{3 z}\end{matrix} ) - ( \begin{matrix}{d}_{1 {x}_{0}} + Δ {d}_{1 x} & {d}_{1 {y}_{0}} + Δ {d}_{1 y} & {d}_{1 {z}_{0}} + Δ {d}_{1 z}\end{matrix} ) \\ {\vec{d}}_{14} = ( \begin{matrix}{d}_{4 {x}_{0}} + Δ {d}_{4 x} & {d}_{4 {y}_{0}} + Δ {d}_{4 y} & {d}_{4 {z}_{0}} + Δ {d}_{4 z}\end{matrix} ) - ( \begin{matrix}{d}_{1 {x}_{0}} + Δ {d}_{1 x} & {d}_{1 {y}_{0}} + Δ {d}_{1 y} & {d}_{1 {z}_{0}} + Δ {d}_{1 z}\end{matrix} ) \\ {\vec{d}}_{23} = ( \begin{matrix}{d}_{3 {x}_{0}} + Δ {d}_{3 x} & {d}_{3 {y}_{0}} + Δ {d}_{3 y} & {d}_{3 {z}_{0}} + Δ {d}_{3 z}\end{matrix} ) - ( \begin{matrix}{d}_{2 {x}_{0}} + Δ {d}_{2 x} & {d}_{2 {y}_{0}} + Δ {d}_{2 y} & {d}_{2 {z}_{0}} + Δ {d}_{2 z}\end{matrix} ) \\ {\vec{d}}_{24} = ( \begin{matrix}{d}_{4 {x}_{0}} + Δ {d}_{4 x} & {d}_{4 {y}_{0}} + Δ {d}_{4 y} & {d}_{4 {z}_{0}} + Δ {d}_{4 z}\end{matrix} ) - ( \begin{matrix}{d}_{2 {x}_{0}} + Δ {d}_{2 x} & {d}_{2 {y}_{0}} + Δ {d}_{2 y} & {d}_{2 {z}_{0}} + Δ {d}_{2 z}\end{matrix} ) \\ {\vec{d}}_{34} = ( \begin{matrix}{d}_{4 {x}_{0}} + Δ {d}_{4 x} & {d}_{4 {y}_{0}} + Δ {d}_{4 y} & {d}_{4 {z}_{0}} + Δ {d}_{4 z}\end{matrix} ) - ( \begin{matrix}{d}_{3 {x}_{0}} + Δ {d}_{3 x} & {d}_{3 {y}_{0}} + Δ {d}_{3 y} & {d}_{3 {z}_{0}} + Δ {d}_{3 z}\end{matrix} ) \qquad ( 1 )$$

where d₁₂ is a distance between the corners 104(1) and 104(2), d₁₃ is a distance between the corners 104(1) and 104(3), d₁₄ is a distance between the corners 104(1) and 104(4), d₂₃ is a distance between the corners 104(2) and 104(3), d₂₄ is a distance between the corners 104(2) and 104(4), and d₃₄ is a distance between the corners 104(3) and 104(4). The subscripts ‘ix₀’, where i=1, 2, 3, 4, refers to a distance of a corner from the origin O in FIG. 5, along the X-axis. Likewise, the subscripts ‘iy₀’ and iz₀′ where i=1, 2, 3, 4, refers to a distance of a corner ‘i’ from the origin O in FIG. 5, along the Y and the Z axes, respectively. The term Δdᵢₓ refers to a change in the position of an i^{th} corner, i=1, 2, 3, 4, along the X-axis. Likewise, the terms Δd_{iy}, Δd_{iz} refer to changes in the position of an i^{th} corner, i=1, 2, 3, 4, along the Y-axis and the Z-axis, respectively. The corner 104(1) may be at a position vector R_{d1} from the point 504 that now acts as a reference point, the corner 104(1) may be at a position vector R_{d1} from the point 504 that now acts as a reference point, the corner 104(2) may be at a position vector R_{d2} from the point 504, the corner 104(3) may be at a position vector R_{d3} from the point 504 that now acts as a reference point, and so on, based for example, upon the relation shown in FIG. 5.

The processor 116 then determines the first normal n₁₂₄, the second normal n₃₄₂, the third normal n₄₁₃ and the fourth normal n₂₃₁ for calculating warpage as given by eq. (2):

$${\vec{n}}_{342} = \frac{( {\vec{d}}_{34} \times {\vec{d}}_{32} )}{\vert {\vec{d}}_{34} \times {\vec{d}}_{32} \vert} , {\vec{n}}_{124} = \frac{( {\vec{d}}_{12} \times {\vec{d}}_{14} )}{\vert {\vec{d}}_{12} \times {\vec{d}}_{14} \vert} , {\vec{n}}_{413} = \frac{( {\vec{d}}_{41} \times {\vec{d}}_{43} )}{\vert {\vec{d}}_{41} \times {\vec{d}}_{43} \vert} , {\vec{n}}_{231} = \frac{( {\vec{d}}_{23} \times {\vec{d}}_{21} )}{\vert {\vec{d}}_{23} \times {\vec{d}}_{21} \vert} \qquad ( 2 )$$

The cross products in equation (2) may be calculated by the vector product module 120 of the processor 116. In one aspect, the processor 116 may compute new coordinate systems, as indicated in Table I to account for the change in coordinates due to warpage, where the subscripts of the vectors indicate vectors in the relative directions of the corners i, j, i=1, 2, 3, 4, and j=1, 2, 3, 4. The reason a new coordinate system is calculated is because as the plurality of corners 104(1)-104(4) displace from a rest position, the planes of the triangles rotate in the inertial reference frame. In order to determine the normals of these planes, the processor 116 determines the coordinate system that rotates with this plane. Once the new coordinate system is determined, the original normal may be transformed to the new coordinate system. The transformed normals may then be used to calculate the angles representing warpage, skewness, bending etc. Table I lists one such exemplary transformation of the coordinate system, although additional or subsequent transformations may also be carried out by the processor 116 for characterization of the severity of machine events.

TABLE I

| Unit Vectors (i, j, k) in Initial | Unit Vectors (i″, j″, k″) in New |
|---|---|
| Coordinate System | Coordinate System |
| ${{i}^{->}}_{13} = \frac{{{d}^{->}}_{13}}{\vert {{d}^{->}}_{13} \vert} \qquad$ | ${{i}^{->}}_{13}^{″} = \frac{{{d}^{->}}_{13}}{\vert {{d}^{->}}_{13} \vert}$ |
| ${{i}^{->}}_{12} = \frac{{{d}^{->}}_{12}}{\vert {{d}^{->}}_{12} \vert}$ | ${{i}^{->}}_{14}^{″} = \frac{{{d}^{->}}_{14}}{\vert {{d}^{->}}_{14} \vert}$ |
| ${{j}^{->}}_{13} = \frac{( {{i}^{->}}_{12} \times {{i}^{->}}_{13} )}{\vert {{i}^{->}}_{12} \times {{i}^{->}}_{13} \vert}$ | ${j}_{13}^{″} = \frac{( {i}_{13}^{″} \times {i}_{14}^{″} )}{\vert {i}_{13}^{″} \times {i}_{14}^{″} \vert}$ |
| ${{k}^{->}}_{13} = {{i}^{->}}_{13} \times {{j}^{->}}_{13}$ | ${{k}^{->}}_{13}^{″} = {{i}^{->}}_{13}^{″} \times {{j}^{->}}_{13}^{″}$ |
| ${{i}^{->}}_{24} = \frac{{{d}^{->}}_{24}}{\vert {{d}^{->}}_{24} \vert}$ | ${{i}^{->}}_{24}^{″} = \frac{{{d}^{->}}_{24}}{\vert {{d}^{->}}_{24} \vert}$ |
| ${{i}^{->}}_{21} = \frac{{{d}^{->}}_{21}}{\vert {{d}^{->}}_{21} \vert}$ | ${{i}^{->}}_{23}^{″} = \frac{{{d}^{->}}_{23}}{\vert {{d}^{->}}_{23} \vert}$ |
| ${{j}^{->}}_{24} = \frac{( {{i}^{->}}_{24} \times {{i}^{->}}_{21} )}{\vert {{i}^{->}}_{24} \times {{i}^{->}}_{21} \vert}$ | ${j}_{24}^{″} = \frac{( {i}_{23}^{″} \times {i}_{24}^{″} )}{\vert {i}_{23}^{″} \times {i}_{24}^{″} \vert}$ |
| ${{k}^{->}}_{24} = {{i}^{->}}_{24} \times {{j}^{->}}_{24}$ | ${{k}^{->}}_{24}^{″} = {{i}^{->}}_{24}^{″} \times {{j}^{->}}_{24}^{″}$ |

where the subscripts m, n (m, n=1, 2, 3, 4) correspond to the plurality of corners 104(1)-104(4).

In one aspect, the vector product module 120 computes new normals n′₁₂₄, n′₃₄₂ based upon Table I as given in equation (3) (approximating normal n′₄₁₃ and n′₂₃₁ to zero):

$$\begin{matrix}{\vec{n}}_{124}^{′} = [ \begin{matrix}( {\vec{n}}_{124} ∘ {\vec{i}}_{13} ) & ( {\vec{n}}_{124} ∘ {\vec{j}}_{13} ) & ( {\vec{n}}_{124} ∘ {\vec{k}}_{13} )\end{matrix} ] \\ = [ \begin{matrix}( {\vec{n}}_{{124}_{x}}^{′} ) & ( {\vec{n}}_{{124}_{y}}^{′} ) & ( {\vec{n}}_{{124}_{z}}^{′} )\end{matrix} ]\end{matrix} \\ \begin{matrix}{\vec{n}}_{342}^{′} = [ \begin{matrix}( {\vec{n}}_{342} ∘ {\vec{i}}_{13} ) & ( {\vec{n}}_{342} ∘ {\vec{j}}_{13} ) & ( {\vec{n}}_{342} ∘ {\vec{k}}_{13} )\end{matrix} ] \\ = [ \begin{matrix}( {\vec{n}}_{{342}_{x}}^{′} ) & ( {\vec{n}}_{{342}_{y}}^{′} ) & ( {\vec{n}}_{{342}_{z}}^{′} )\end{matrix} ]\end{matrix} \qquad ( 3 )$$

Further transformed normals for the new coordinates may then be calculated by the vector product module 120 as normals n″₁₂₄, n″₃₄₂ based upon Table I as given in equation (4) (approximating normal n″₄₁₃ and n″₂₃₁ to zero):

$$\begin{matrix}{\vec{n}}_{124}^{″} = [ \begin{matrix}( {\vec{n}}_{124} ∘ {\vec{i}}_{13}^{″} ) & ( {\vec{n}}_{124} ∘ {\vec{j}}_{13}^{″} ) & ( {\vec{n}}_{124} ∘ {\vec{k}}_{13}^{″} )\end{matrix} ] \\ = [ \begin{matrix}( {\vec{n}}_{{124}_{x}}^{″} ) & ( {\vec{n}}_{{124}_{y}}^{″} ) & ( {\vec{n}}_{{124}_{z}}^{″} )\end{matrix} ]\end{matrix} \\ \begin{matrix}{\vec{n}}_{342}^{″} = [ \begin{matrix}( {\vec{n}}_{342} ∘ {\vec{i}}_{13}^{″} ) & ( {\vec{n}}_{342} ∘ {\vec{j}}_{13}^{″} ) & ( {\vec{n}}_{342} ∘ {\vec{k}}_{13}^{″} )\end{matrix} ] \\ = [ \begin{matrix}( {\vec{n}}_{{342}_{x}}^{″} ) & ( {\vec{n}}_{{342}_{y}}^{″} ) & ( {\vec{n}}_{{342}_{z}}^{″} )\end{matrix} ]\end{matrix} \\ \begin{matrix}{\vec{n}}_{231}^{″} = [ \begin{matrix}( {\vec{n}}_{231} ∘ {\vec{i}}_{24} ) & ( {\vec{n}}_{231} ∘ {\vec{j}}_{24}^{″} ) & ( {\vec{n}}_{231} ∘ {\vec{k}}_{24}^{″} )\end{matrix} ] \\ = [ \begin{matrix}( {\vec{n}}_{{231}_{x}}^{″} ) & ( {\vec{n}}_{{231}_{y}}^{″} ) & ( {\vec{n}}_{{231}_{z}}^{″} )\end{matrix} ]\end{matrix} \\ \begin{matrix}{\vec{n}}_{413}^{″} = [ \begin{matrix}( {\vec{n}}_{413} ∘ {\vec{i}}_{24}^{″} ) & ( {\vec{n}}_{413} ∘ {\vec{j}}_{24}^{″} ) & ( {\vec{n}}_{413} ∘ {\vec{k}}_{24}^{″} )\end{matrix} ] \\ = [ \begin{matrix}( {\vec{n}}_{{413}_{x}}^{″} ) & ( {\vec{n}}_{{413}_{y}}^{″} ) & ( {\vec{n}}_{{413}_{z}}^{″} )\end{matrix} ]\end{matrix} \qquad ( 4 )$$

The processor 116 may then calculate the first warpage angle φ₁ and the warpage angle φ₂ as well as a first transformed warpage angle φ′₁ and a second transformed warpage angle φ′₂ as shown in equation (5):

$${φ}_{1} = \pm a sin ( {{n}^{->}}_{124}^{′} \times {{n}^{->}}_{342}^{′} ) or {φ}_{1}^{′} = \pm a sin ( {{n}^{->}}_{124}^{″} \times {{n}^{->}}_{342}^{″} ) \\ {φ}_{2} = \pm a sin ( {{n}^{->}}_{231}^{′} \times {{n}^{->}}_{413}^{′} ) or {φ}_{2}^{′} = \pm a sin ( {{n}^{->}}_{231}^{″} \times {{n}^{->}}_{413}^{″} ) \qquad ( 5 )$$

where a is a scaling parameter, and:

$${{n}^{->}}_{124}^{′} \times {{n}^{->}}_{342}^{′} = {{n}^{->}}_{{124}_{x}}^{′} \times {{n}^{->}}_{{342}_{y}}^{′} - {{n}^{->}}_{{124}_{y}}^{′} \times {{n}^{->}}_{{342}_{x}}^{′} \\ {{n}^{->}}_{124}^{″} \times {{n}^{->}}_{342}^{″} = {{n}^{->}}_{{124}_{x}}^{″} \times {{n}^{->}}_{{342}_{y}}^{″} - {{n}^{->}}_{{124}_{y}}^{″} \times {{n}^{->}}_{{342}_{x}}^{″} \\ {{n}^{->}}_{231}^{′} \times {{n}^{->}}_{413}^{′} = {{n}^{->}}_{{231}_{x}}^{′} \times {{n}^{->}}_{{413}_{y}}^{′} - {{n}^{->}}_{{231}_{y}}^{′} \times {{n}^{->}}_{{413}_{x}}^{′} \\ {{n}^{->}}_{231}^{″} \times {{n}^{->}}_{413}^{″} = {{n}^{->}}_{{231}_{x}}^{″} \times {{n}^{->}}_{{413}_{y}}^{″} - {{n}^{->}}_{{231}_{y}}^{″} \times {{n}^{->}}_{{413}_{x}}^{″} \qquad ( 6 )$$

where the subscripts x, y, and z refer to components along the x, y, and z axes of a Cartesian coordinate system. The processor 116 may then determine a level of severity of the warpage encountered by the machine 102 and/or the machine component 104 based upon an operator:

$$max min [ {φ}_{1} , {φ}_{1}^{′} , {φ}_{2} , {φ}_{2}^{′} ] ,$$

where the “maxmin” operator indicates either a maximum or a minimum value of the warpage angles φ₁, φ₂, φ′₁, φ′₂. In one aspect, the “maxmin” operator is optional and may only be used as an indicator of a worst-case scenario for a machine event. The new normals determined in the eqs. (4)-(6) may be used to represent a deformation angle as a function of time, which may be a suitable proxy for the severity of a machine event.

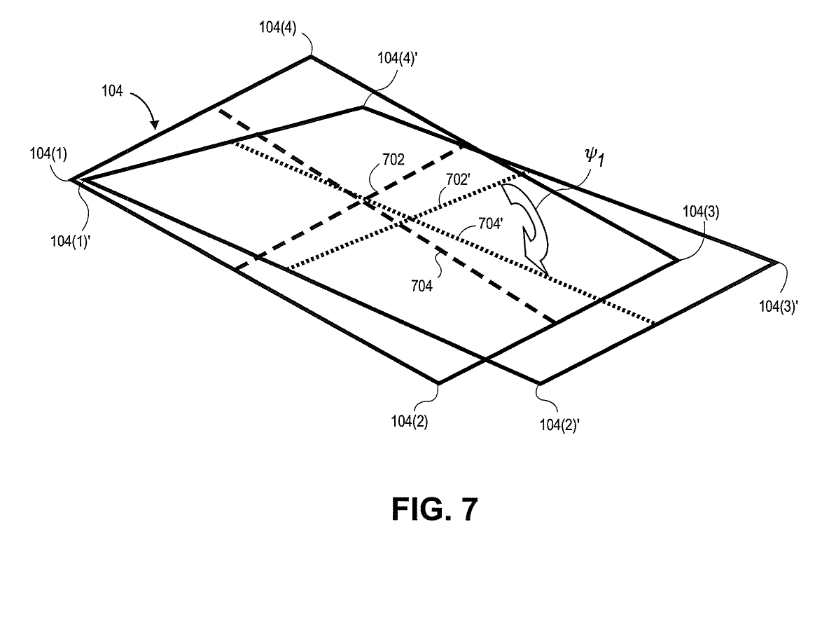

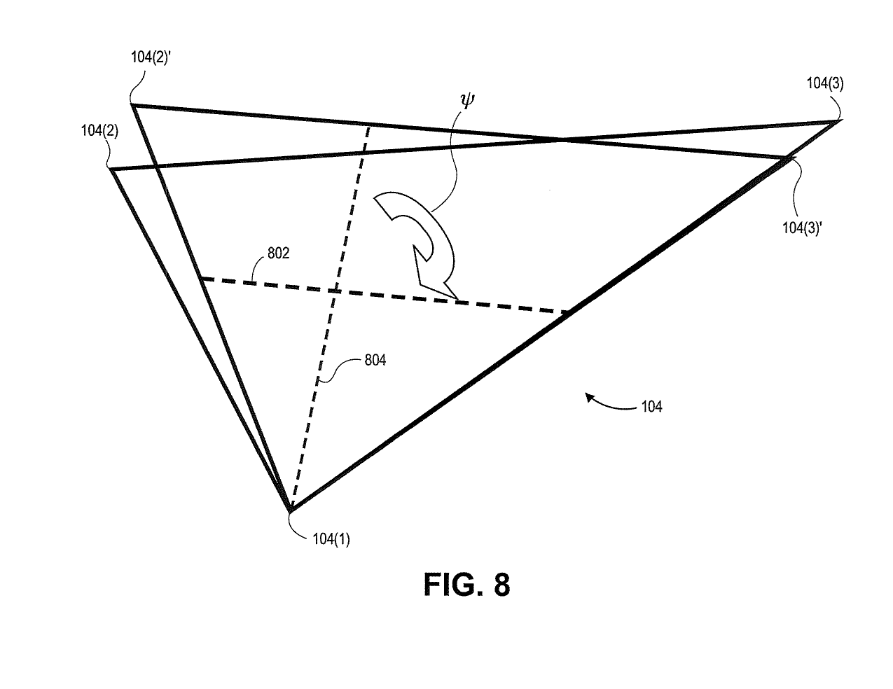

Referring back to FIG. 2, in an operation 212, the vector product module 120 of the processor 116 may calculate a shearing or skewness encountered by the machine 102 and/or the machine component 104. Such shearing or skewness may be calculated as discussed with respect to FIGS. 7 and 8. FIG. 7 illustrates an initial position of the machine component 104 with the plurality of corners 104(1)-104(4). As discussed, the plurality of accelerometers 106(1)-106(4) are respectively placed on each of the plurality of corners 104(1)-104(4). The measurements produced from the plurality of accelerometers 106(1)-106(4) form a quadrangle. As a result of a machine event, the machine component 104 may get skewed or sheared. The plurality of corners 104(1)-104(4) may be displaced to new positions indicated by 104(1)′-104(4)′, respectively. Such displacement may be temporary or permanent, and is associated with accelerations of each of the plurality of corners 104(1)-104(4) picked up by the plurality of accelerometers 106(1)-106(4), respectively, and outputted as voltages. The processor 116 may initially store in the memory 122 an initially unskewed geometry of the machine component 104. For example, a pair of lines 702, 704 joining opposite mid-sides of the machine component 104 may be determined by the processor 116 before operation of the machine 102 and/or the machine component 104. Subsequently, the pair of lines 702, 704 are displaced to a new pair of lines 702′ and 704′, respectively. The processor 116 may determine a skew angle Ψ₁ between the lines 702′ and 704′. Skew in quadrangles formed by the plurality of corners 104(1)-104(4) is calculated by finding a minimum angle between the two lines 702′ and 704′ joining opposite mid-sides of the quadrangle. In one aspect, ninety degrees minus the minimum angle in a set of angles may be calculated by the processor 116 and stored in the memory 122 to determine the skew. The processor 116 may calculate the skew angles Ψᵢ=1, 2, 3, 4 using equations (7) as (with only one skew angle Ψ₁ being illustrated in FIG. 7):

$${ψ}_{1} = 90 - a cos ( \frac{( {{d}^{->}}_{12} ∘ {{d}^{->}}_{14} )}{\vert {{d}^{->}}_{12} \vert \vert {{d}^{->}}_{14} \vert} ) \\ {ψ}_{2} = 90 - a cos ( \frac{( {{d}^{->}}_{21} ∘ {{d}^{->}}_{23} )}{\vert {{d}^{->}}_{21} \vert \vert {{d}^{->}}_{23} \vert} ) \\ {ψ}_{3} = 90 - a cos ( \frac{( {{d}^{->}}_{32} ∘ {{d}^{->}}_{34} )}{\vert {{d}^{->}}_{32} \vert \vert {{d}^{->}}_{34} \vert} ) \\ {ψ}_{4} = 90 - a cos ( \frac{( {{d}^{->}}_{41} ∘ {{d}^{->}}_{43} )}{\vert {{d}^{->}}_{41} \vert \vert {{d}^{->}}_{43} \vert} ) \qquad ( 7 )$$

The vectors dᵢⱼ=1, 2, 3, 4, correspond respectively to relative distances between each of the plurality of corners 104(1)-104(4). The dot products in the numerators of the skew angles Ψᵢ may be computed by the vector product module 120 of the processor 116. In one aspect, the vectors dᵢⱼ may be determined in a manner similar to that discussed with respect to FIGS. 5 and 6 in the operation 210. The processor 116 may then determine a level of severity of the skewness encountered by the machine 102 and/or the machine component 104 based upon an operator:

maxmin[Ψ₁,Ψ₂,Ψ₃,Ψ₄]

where the “maxmin” operator indicates either a maximum or a minimum value of the skewness angles Ψᵢ, i=1, 2, 3, 4.

FIG. 8 illustrates calculation of skew or shear in triangles. As discussed with respect to FIGS. 3 and 4, such triangles may be formed by three out of four of the plurality of corners 104(1)-104(4). That is, when the machine component 104 is of a rectangular shape, four such sets of triangles may be determined by the processor 116, taking three corners at a time. In one aspect, the triangles may be used when the machine 102 and/or the machine component 104 has a triangular geometry, in which case only one triangle will exist. Skew in triangles is calculated by processor 116 determining a minimum angle ψ between a vector 802 from each node of the triangle formed by the corners 104(1)-104(3), for example, to the opposite mid side and a vector 804 between two adjacent mid sides at each node of the triangle formed by the corners 104(1)-104(3), for example. The processor 116 may then determine ninety degrees minus the minimum angle as the skew for the machine 102 and/or the machine component 104, per eq. (7) and the “maxmin” operator.

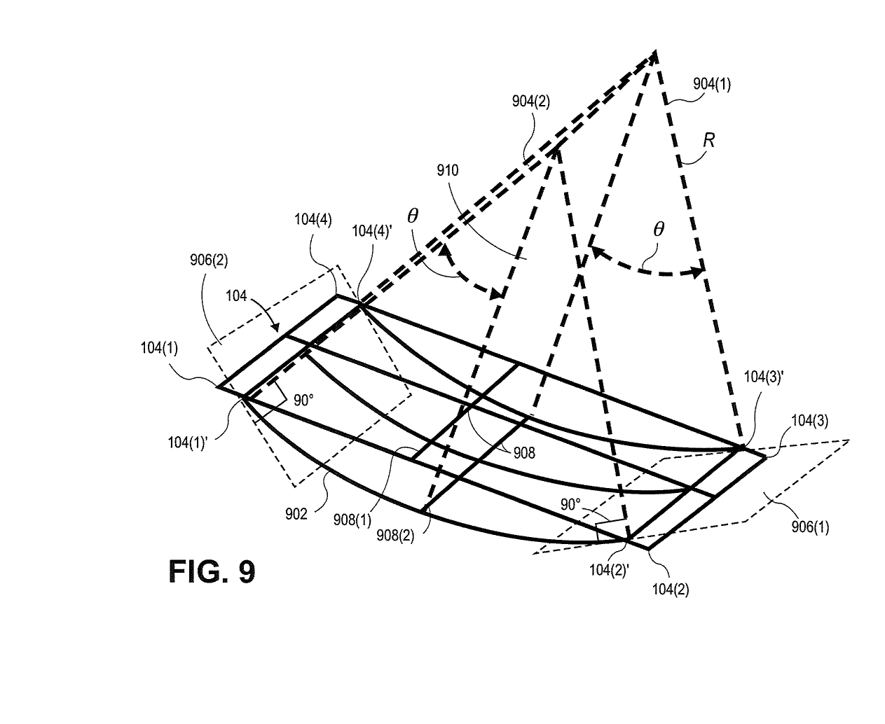

Referring back to FIG. 2, in an operation 214, the vector product module 120 of the processor 116 may be used to calculate a bending encountered by the machine 102 and/or the machine component 104 due to a machine event. Such bending may be calculated by the processor 116 as discussed with respect to FIG. 9. FIG. 9 illustrates an initial unbent plane shape of the machine component 104. A machine event may cause the machine component 104 to bend to a shape 902. Such bending may occur about a central axis 908 of the machine component 104, although other asymmetrical bending axes may be determined by the processor 116. The central axis 908 is in a first position 908(1) when the machine component 104 is in an unbent shape and is in a second position 908(2) when the machine component 104 bends due to a machine event. To characterize the severity of such a machine event, the processor 116 may determine new positions 104(1)′-104(4)′ to which the plurality of corners 104(1)-104(4), respectively, move to due to the machine event. The processor 116 may then determine a plane 904(1) orthogonal to a tangential plane 906(1) at the new positions 104(2)′ and 104(3)′ corresponding to the corners 104(2) and 104(3), respectively. Likewise, the processor 116 may then determine a plane 904(2) orthogonal to a tangential plane 906(2) at the new positions 104(1)′ and 104(4)′ corresponding to the corners 104(1) and 104(4), respectively. The plane 904(1) and the plane 904(2) are at a solid angle θ with respect to a plane 910 joining the two positions 908(1) and 908(2) of the central axis 908. Further, the planes 904(1) and 904(2) meet at a distance R from respective new positions 104(2)′, 104(3)′ and 104(1)′, 104(4)′. It is to be noted that when the bending of the machine component 104 is asymmetrical, the angle θ and the distance R may not be the same for the planes 904(1) and 904(2). The radius of the curved plane having the shape 902 may be determined from the distance R. The processor 116 may then determine an average distance dₐᵥₑ that the plurality of corners 104(1)-104(4) may move using eq. (8):

$${\vert {d}^{->} \vert}_{ave} = \frac{\vert {{d}^{->}}_{12} + {{d}^{->}}_{43} \vert}{2} \qquad ( 8 )$$

where d₁₂ and d₄₃ are the relative distances between the corners 104(1), 104(2) and 104(3), 104(4), respectively. The processor may calculate an original position vector magnitude S₀ with the relative distances between the corners 104(1), 104(2) and 104(3), 104(4), respectively at a time t=t₀ using eq. (9):

$${\vert {s}^{->} \vert}_{0} = \frac{{\vert {{d}^{->}}_{12} + {{d}^{->}}_{43} \vert}_{t = 0}}{2} \qquad ( 9 )$$

From eqs. (8) and (9), the processor 116 may calculate an angle α′ using eq. (10):

$${α}^{′} = arc sin ( \frac{{\vert {d}^{->} \vert}_{ave}}{{\vert {s}^{->} \vert}_{0}} ) \qquad ( 10 )$$

Eq. (10) may be used by the processor 116 to obtain a time parameter ‘t’, as indicated in eq. (11):

$$t = \frac{{\vert {s}^{->} \vert}_{0}}{2} cos ( {α}^{′} ) \qquad ( 11 )$$

Using eq. (11), the processor 116 may calculate the angle θ by solving for a function f(θ) in eq. (12):

f(θ)=C sin²(θ)+sin(θ)cos(θ)−θ (12)

where:

$$C = \frac{2 t}{{\vert {d}^{->} \vert}_{ave}} \qquad ( 13 )$$

The processor 116 may then calculate a derivative function f′(θ) given by the eq. (14):

f′(θ)=cos²(θ)+2C sin(θ)cos(θ)−sin²(θ)−1 (14)

To solve for θ, in one aspect, the processor 116 may then guess or select a value of θ previously available, e.g., stored in the memory 122. Such an older value of θ is denoted as θ_{old}. Based upon a selected value of θ_{old}, for each time instant t, a new value of θ, denoted by θ_{new} is calculated using eq. (15):

θ_{new}=θ_{old}−[f(θ)/f′(θ)] (15)

The processor 116 may then determine the distance R using eq. (16):

$$R = \frac{{\vert {d}^{->} \vert}_{ave}}{2 sin θ} \qquad ( 16 )$$

For each angle θ calculated for a set of time instants t, a curvature κ, also referred to as a bending coefficient or curvature parameter κ, is computed by the processor 116 using eq. (17):

κ=1/R (17)

A set of such curvature parameters {κᵢ}, where i is an integer, is then computed by the processor 116. To characterize the severity of the machine event in terms of bending, the processor 116 may then determine bending using a maximum value of κ in the set {κᵢ}. In one aspect, determining the bending includes calculating a degree in terms of the angle θ to which a curved line or the curved or bent shape 902 of the surface of the machine component 104 deviates from a straight line or a plane, respectively, using the eqs. (8)-(17).

In one alternative aspect, bending may be calculated by the processor 116 in a different way. An exponential moving average dₑₘₐ for a displacement d may be calculated by the processor 116 with a smoothing factor, α, set to 0.9, although other values of a could be used. The bending coefficient, κ, is then computed for an ith member of the set of curvature parameters as given by eq. (17a):

κᵢ=(dₐᵥₑ₍ᵢ₎−dₑₘₐ₍₀₎)/dₑₘₐ₍ᵢ₎ (17a)

The bending coefficient x the degree to which a curved line or a curved plane (depending upon whether the machine component 104 is one dimensional or two dimensional in a plan view) differs from the time-weighted average of itself, as indicated by eq. (17a).

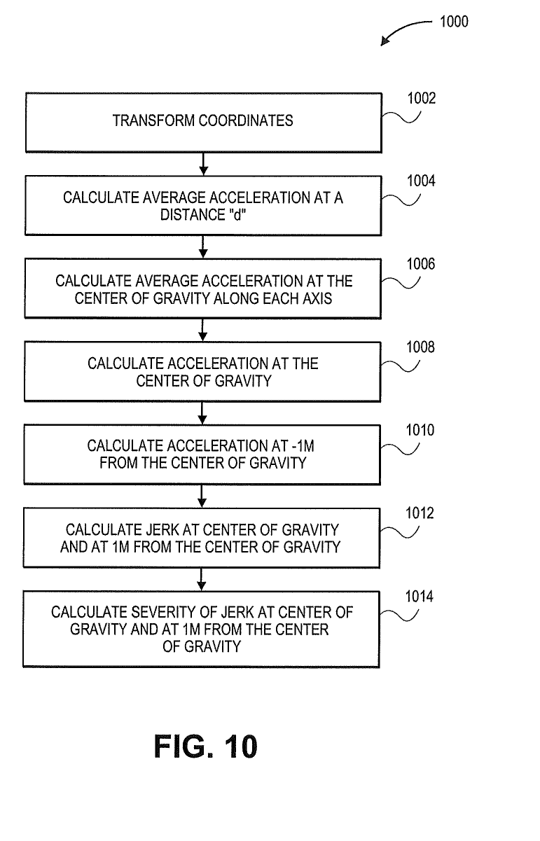

Referring back to FIG. 2, in an operation 216, a jerk experienced by the machine 102 and/or the machine component 104 is calculated by the processor 116. Jerking is a machine event that may be associated, for example, with roll, pitch, or yaw parameters of the machine 102 and/or the machine component 104. In one aspect, the jerk is a rotational event. In another aspect, the jerk is a combination of rotational and linear acceleration events detected by the plurality of accelerometers 106(1)-106(4). The calculation of jerk may be carried out for any point of the body of the machine component 104 and/or the machine 102. By way of example only and not by way of limitation, the jerk may be calculated by the processor 116 at a center of gravity of the machine 102 and/or the machine component 104. In one aspect, calculation of jerk at the center of gravity may then be used to calculate the jerk (rotational and/or linear) at, for example, 1 m from the center of gravity in any direction. The calculation of jerk by the processor 116 is discussed with respect to FIG. 10 and eqs. (18)-(33).

Referring to FIG. 10, a flowchart illustrates method 1000 for calculation of jerk experienced by the machine 102 and/or the machine component 104. The method 1000 may begin with an operation 1002 where a transformation of coordinates from an inertial frame to a body frame is carried out. Examples of such an inertial frame and body frame include those discussed with respect to FIG. 5. To determine the transformations, the processor 116 may use a general acceleration equation expressed in eq. (18) as a differential of time:

$$\frac{{ }^{i} {d}^{2} r}{{dt}^{2}} = \frac{{ }^{i} {d}^{2} {r}^{c}}{{dt}^{2}} + \frac{{ }^{i} {d}^{2} {r}^{d}}{{dt}^{2}} + \frac{{ }^{i} {d}^{2} {r}^{f}}{{dt}^{2}} \qquad ( 18 )$$

where i indicates the general acceleration equation with respect to the inertial frame of reference, r is a position vector of a general point on the machine component 104, r^{c} is a position vector of the center of gravity, r^{d} is a position vector of a distance to a particular point from the center of gravity and r^{f} is a position vector of a point undergoing a flexible deflection. Eq. (18) is a simple linear transform that assumes small angle approximation, which means rotations of only a few degrees. Another condition for eq. (18) is that it takes acceleration values from six distinct directions and the locations and directions must be chosen in a manner such that they define six degree motion of a rigid body, e.g., the machine 102 and/or the machine component 104. If over six inputs are used, then the problem becomes over-constrained and the solution is a least-squared best fit of all the data. Generally, d²r^{f}/dt² is negligible and may be considered to be equal to zero by the processor 116, leading to a simplified eq. (19):

$$\frac{{ }^{i} {d}^{2} r}{{dt}^{2}} \approx \frac{{ }^{i} {d}^{2} {r}^{c}}{{dt}^{2}} + \frac{{ }^{i} {d}^{2} {r}^{d}}{{dt}^{2}} \qquad ( 19 )$$

The processor 116 then makes a substitution of id²r^{c}/dt² to be an average value of acceleration measurements received from the plurality of accelerometers 106(1)-106(4) as provided in eq. (20):

$$\frac{{ }^{i} {d}^{2} {r}^{c}}{{dt}^{2}} = ave ( \ddot{s} ) \qquad ( 20 )$$

where ‘s’ is a displacement value obtained from the DSP module 118, for example, and (\ddot{s}) is the measured value of the acceleration, as obtained from one or more of the plurality of accelerometers 106(1)-106(4).

In an operation 1004, the processor 116 calculates an average value of the acceleration of a point at a distance ‘d’ from the center of gravity as using eq. (21):

$$\frac{{ }^{i} {d}^{2} {r}^{d}}{{dt}^{2}} = \frac{{ }^{i} {d}^{2} r}{{dt}^{2}} - ave ( \ddot{s} ) = {\{ b \}}^{T} {[}^{i} {{ω}^{->}}_{i}^{b i} {{ω}^{->}}_{b}^{b } {+}^{i} {{ω}^{{.}^{->}}}_{b}^{b } ] {r}_{b}^{d} = a \qquad ( 21 )$$

where ‘b’ refers to the body frame of reference (e.g., as discussed with respect to FIG. 5), ‘T’ is a transpose of matrix operation, co is an angular velocity at the point distant ‘d’ from the center of gravity, and a is the average value of the acceleration. The values of w may be determined by the processor 116 using eqs. (22):

$${ }^{i} {{ω}^{->}}_{b}^{b } = {\{ \begin{matrix}{ω}_{x} \\ {ω}_{y} \\ {ω}_{z}\end{matrix} \} \\}^{i} {{\dot{ω}}^{->}}_{b}^{b } = \{ \begin{matrix}{\dot{ω}}_{x} \\ {\dot{ω}}_{y} \\ {\dot{ω}}_{z}\end{matrix} \} \\ \frac{{\ddot{x}}_{1} - {\ddot{x}}_{2}}{{d}_{12}} = {\dot{ω}}_{y} , \\ \int {\dot{ω}}_{y} = {ω}_{y} \\ \frac{{\ddot{y}}_{2} - {\ddot{y}}_{1}}{{d}_{12}} = {\dot{ω}}_{x} , \\ \int {\dot{ω}}_{x} = {ω}_{x} \\ \frac{{\ddot{y}}_{3} - {\ddot{y}}_{2}}{{d}_{12}} = {\dot{ω}}_{z} , \\ \int {\dot{ω}}_{z} = {ω}_{z} \qquad ( 22 )$$

where subscripts x, y, and z refer to components of co in the Cartesian coordinates, and dᵢⱼ, i, j=1, 2 being relative distances between any two points on the machine component 104.

In an operation 1006, the processor 116 may determine the average acceleration at the center of gravity of the machine component 104 using eq. (23):

$$a = [ {}_{ }^{i}{\vec{ω}}{}_{b}^{b} {}_{ }^{i}{\vec{ω}}{}_{b}^{b} + {}_{ }^{i}{\vec{\dot{ω}}}{}_{b}^{b} ] {r}_{cg} \qquad ( 23 )$$

From eq. (23), the processor 116 may determine a position r_{cg} of the center of gravity as given in eq. (24):

$${r}_{cg} = {[ {}_{ }^{i}{\vec{ω}}{}_{b}^{b} {}_{ }^{i}{\vec{ω}}{}_{b}^{b} + {}_{ }^{i}{\vec{\dot{ω}}}{}_{b}^{b} ]}^{- 1} a \qquad ( 24 )$$

In an operation 1008, knowing r_{cg}, the processor 116 may calculate acceleration at the center of gravity along the X, Y, and Z axes using eq. (25):

$$[ \frac{{ }^{i} {d}^{2} r}{{dt}^{2}} {\vert}_{CG} ] = ( [ \frac{{ }^{i} {d}^{2} r}{{dt}^{2}} {\vert}_{{CG}_{X}} ] [ \frac{{ }^{i} {d}^{2} r}{{dt}^{2}} {\vert}_{{CG}_{Y}} ] [ \frac{{ }^{i} {d}^{2} r}{{dt}^{2}} {\vert}_{{CG}_{Z}} ] ) \qquad ( 25 )$$

In an operation 1010, the processor 116 may then calculate acceleration at a distance from the center of gravity, e.g., at 1 m from the center of gravity along the X, Y, and Z axes using eq. (26):

$$\frac{{}_{ }^{i}{d}{}_{ }^{2} r}{{dt}^{2}} {\vert}_{1 m} = \sqrt{{( \frac{{}_{ }^{i}{d}{}_{ }^{2} r}{{dt}^{2}} {\vert}_{1 {m}_{X}} )}^{2} + {( \frac{{}_{ }^{i}{d}{}_{ }^{2} r}{{dt}^{2}} {\vert}_{1 {m}_{Y}} )}^{2} + {( \frac{{}_{ }^{i}{d}{}_{ }^{2} r}{{dt}^{2}} {\vert}_{1 {m}_{Z}} )}^{2}} \qquad ( 26 )$$

In an operation 1012, the processor 116 may determine a jerk experienced by the machine component 104 and/or the machine 102 at the center of gravity, and at 1m from the center of gravity, using eqs. (27) and (28), respectively:

$$\begin{matrix}\frac{d}{dt} [ \frac{{}_{ }^{i}{d}{}_{ }^{2} r}{{dt}^{2}} {\vert}_{CG} ] = ( \frac{d}{dt} ⌊ \frac{{}_{ }^{i}{d}{}_{ }^{2} r}{{dt}^{2}} {\vert}_{{CG}_{X}} ⌋ \frac{d}{dt} ⌊ \frac{{}_{ }^{i}{d}{}_{ }^{2} r}{{dt}^{2}} {\vert}_{{CG}_{Y}} ⌋ \frac{d}{dt} ⌊ \frac{{}_{ }^{i}{d}{}_{ }^{2} r}{{dt}^{2}} {\vert}_{{CG}_{Z}} ⌋ ) & ( 27 ) \\ \frac{d}{dt} [ \frac{{}_{ }^{i}{d}{}_{ }^{2} r}{{dt}^{2}} {\vert}_{1 m} ] = ( \frac{d}{dt} [ \frac{{}_{ }^{i}{d}{}_{ }^{2} r}{{dt}^{2}} {\vert}_{1 {m}_{X}} ] \frac{d}{dt} [ \frac{{}_{ }^{i}{d}{}_{ }^{2} r}{{dt}^{2}} {\vert}_{1 {m}_{Y}} ] \frac{d}{dt} [ \frac{{}_{ }^{i}{d}{}_{ }^{2} r}{{dt}^{2}} {\vert}_{1 {m}_{Z}} ] ) & ( 28 )\end{matrix}$$

As noted in eq. (27), the jerk at the center of gravity is calculated by the processor 116 using a time derivative of eq. (25) in eq. (27). Likewise, the jerk at 1 m from the center of gravity is calculated by the processor 116 using a time derivative of eq. (26) as shown in eq. (28). In one aspect, the time derivatives in eqs. (27) and (28) may be computed by the DSP module 118.

In an operation 1014, the processor 116 may determine the severity of the jerk by determining a maximum value of accelerations and jerks at the center of gravity, and at 1 m from the center of gravity. The jerk may be measured in units of m/s³. For example, the maximum acceleration at the center of gravity of the machine 102 is determined by eq. (29):

$$‖ \frac{{}_{ }^{i}{d}{}_{ }^{2} r}{{dt}^{2}} {\vert}_{CG} ‖ = \sqrt{{( \frac{{}_{ }^{i}{d}{}_{ }^{2} r}{{dt}^{2}} {\vert}_{{CG}_{X}} )}^{2} + {( \frac{{}_{ }^{i}{d}{}_{ }^{2} r}{{dt}^{2}} {\vert}_{{CG}_{Y}} )}^{2} + {( \frac{{}_{ }^{i}{d}{}_{ }^{2} r}{{dt}^{2}} {\vert}_{{CG}_{Z}} )}^{2}} \qquad ( 29 )$$

The maximum acceleration in each direction X, Y, and Z at the center of gravity of the machine is determined by the expression:

$$( ‖ \frac{{}_{ }^{i}{d}{}_{ }^{2} r}{{dt}^{2}} {\vert}_{{CG}_{X}} ‖ ‖ \frac{{}_{ }^{i}{d}{}_{ }^{2} r}{{dt}^{2}} {\vert}_{{CG}_{Y}} ‖ ‖ \frac{{}_{ }^{i}{d}{}_{ }^{2} r}{{dt}^{2}} {\vert}_{{CG}_{Z}} ‖ ) ,$$

where ∥.∥ denotes a mathematical norm operator.

The maximum acceleration at 1 m from the center of gravity is determined by eq. (30):

$${\vert \frac{{}_{ }^{i}{d}{}_{ }^{2} r}{{dt}^{2}} \vert}_{1 m} ‖ = \sqrt{{( \frac{{}_{ }^{i}{d}{}_{ }^{2} r}{{dt}^{2}} {\vert}_{1 {m}_{X}} )}^{2} + {( \frac{{}_{ }^{i}{d}{}_{ }^{2} r}{{dt}^{2}} {\vert}_{1 {m}_{Y}} )}^{2} + {( \frac{{}_{ }^{i}{d}{}_{ }^{2} r}{{dt}^{2}} {\vert}_{1 {m}_{Z}} )}^{2}} \qquad ( 30 )$$

Likewise, the maximum acceleration in each direction X, Y, and Z at 1 m from the center of gravity of the machine is determined by the expression:

$$( ‖ \frac{{}_{ }^{i}{d}{}_{ }^{2} r}{{dt}^{2}} {\vert}_{1 {m}_{X}} ‖ \vert \frac{{}_{ }^{i}{d}{}_{ }^{2} r}{{dt}^{2}} {\vert}_{1 {m}_{Y}} ‖ ‖ \frac{{}_{ }^{i}{d}{}_{ }^{2} r}{{dt}^{2}} {\vert}_{1 {m}_{Z}} \vert ) ,$$

where ∥.∥ denotes a mathematical norm operator.

The processor 116 may similarly calculate, the maximum jerk at the center of gravity of the machine 102 is determined by differentiating eq. (29) with respect to time, as given in eq. (31):

$$\vert \frac{d}{dt} [ \frac{{}_{ }^{i}{d}{}_{ }^{2} r}{{dt}^{2}} {\vert}_{CG} ] \vert = \sqrt{{( \frac{d}{dt} [ \frac{{}_{ }^{i}{d}{}_{ }^{2} r}{{dt}^{2}} {\vert}_{{CG}_{X}} ] )}^{2} + {( \frac{d}{dt} [ \frac{{}_{ }^{i}{d}{}_{ }^{2} r}{{dt}^{2}} {\vert}_{{CG}_{Y}} ] )}^{2} + {( \frac{d}{dt} [ \frac{{}_{ }^{i}{d}{}_{ }^{2} r}{{dt}^{2}} {\vert}_{{CG}_{Z}} ] )}^{2}} \qquad ( 31 )$$

The maximum jerk in each direction X, Y, and Z at the center of gravity of the machine is determined by the expression:

$$( ‖ \frac{d}{dt} [ \frac{{}_{ }^{i}{d}{}_{ }^{2} r}{{dt}^{2}} {\vert}_{{CG}_{X}} ] ‖ ‖ \frac{d}{dt} [ \frac{{}_{ }^{i}{d}{}_{ }^{2} r}{{dt}^{2}} {\vert}_{{CG}_{Y}} ] ‖ ‖ \frac{d}{dt} [ \frac{{}_{ }^{i}{d}{}_{ }^{2} r}{{dt}^{2}} {\vert}_{{CG}_{Z}} ] ‖ ) ,$$

where ∥.∥ denotes a mathematical norm operator.

The maximum jerk at 1 m from the center of gravity is determined by differentiating eq. (30) with respect to time, as given in eq. (32):

$$\vert \frac{d}{dt} [ \frac{{}_{ }^{i}{d}{}_{ }^{2} r}{{dt}^{2}} {\vert}_{1 m} ] ‖ = \sqrt{( {\frac{d}{dt} [ \frac{{}_{ }^{i}{d}{}_{ }^{2} r}{{dt}^{2}} {\vert}_{1 {m}_{X}} )}^{2} + {( \frac{d}{dt} [ \frac{{}_{ }^{i}{d}{}_{ }^{2} r}{{dt}^{2}} {\vert}_{1 {m}_{Y}} ] )}^{2} + {( \frac{d}{dt} [ \frac{{}_{ }^{i}{d}{}_{ }^{2} r}{{dt}^{2}} {\vert}_{1 {m}_{Z}} ] )}^{2}} \qquad ( 32 )$$

Similarly, the maximum jerk in each direction X, Y, and Z at 1 m from the center of gravity of the machine is determined by the expression:

$$( ‖ \frac{d}{dt} [ \frac{{}_{ }^{i}{d}{}_{ }^{2} r}{{dt}^{2}} {\vert}_{1 {m}_{X}} ] ‖ ‖ \frac{d}{dt} [ \frac{{}_{ }^{i}{d}{}_{ }^{2} r}{{dt}^{2}} {\vert}_{1 {m}_{Y}} ] ‖ ‖ \frac{d}{dt} [ \frac{{}_{ }^{i}{d}{}_{ }^{2} r}{{dt}^{2}} {\vert}_{1 {m}_{Z}} ] ‖ ) ,$$

where ∥.∥ denotes a mathematical norm operator.

In one aspect, to determine the jerk experienced by the machine 102 and/or the machine frame 104, the processor 116 may calculate the acceleration due to gravity in the body frame of reference using eq. (33) from the values of acceleration due to gravity in the inertial frame of reference:

$${[ \begin{matrix}{g}_{x}^{′} \\ {g}_{y}^{′} \\ {g}_{z}^{′}\end{matrix} ]}_{Body} = {[ \begin{matrix}{c}_{α} {c}_{γ} & - {c}_{β} {s}_{γ} + {s}_{β} {s}_{α} {c}_{γ} & {s}_{β} {s}_{γ} + {c}_{β} {c}_{α} {c}_{γ} \\ {c}_{α} {s}_{γ} & {c}_{β} {c}_{γ} + {s}_{β} {s}_{α} {s}_{γ} & - {s}_{β} {c}_{γ} + {c}_{β} {s}_{α} {s}_{γ} \\ - {s}_{α} & {s}_{β} {c}_{α} & {c}_{β} {c}_{α}\end{matrix} ] [ \begin{matrix}0 \\ {g}_{γ} \\ o\end{matrix} ]}_{Inertial} \qquad ( 33 )$$

where ‘g’ denotes acceleration due to gravity in m/s², the subscripts x, y, and z are indicative of components along the X, Y, and Z axes, and where:

$${s}_{α} = sin α$$

$${c}_{α} = cos α$$

$${s}_{β} = sin β$$

$${c}_{β} = cos β$$

$${s}_{γ} = sin γ$$

$${c}_{γ} = cos γ ,$$

where α is a pitch angle, β is a roll angle, and γ is a yaw or heading angle for the machine 102 previously measured by the processor 116.

Again referring back to FIG. 2, in an operation 218, based upon the calculations performed by the processor 116 in the operations 210-216, the processor 116 may identify and characterize severity of one or more machine events. The severity of the machine event may be characterized by a combination of the warpage, skew, bending, and jerk computed in the operations 210-216, or only one of the warpage, skew, bending, or jerk may be chosen as an indicator of the severity of the machine event. For example, such severity characterization may be used to identify damage or impact shocks to the machine 102 and/or the machine component 104. In one aspect, the machine events may be visualized as a time evolving animation on the output unit 128 for a user to identify the machine events visually, analyze and correct future operation, production, or assembly of the machine 102 and/or the machine component 104. The results from such characterization may be stored (e.g., as a table or a graph) in the memory 122 for future characterization. Further, such characterization may be used to determine a more accurate positioning of the plurality of accelerometers 106(1)-106(4) based upon the recorded history of machine events in the memory 122. In one aspect, the processor 116 may characterize the severity of a machine event based upon additional sources of data, e.g., data from an inertial measurement unit (IMU), from a global navigation satellite system (GNSS), from a global positioning system (GPS), and/or from additional sensors (e.g., a camera) on the machine 102 and/or on the machine component 104. Alternatively, such additional sources of data for characterizing the severity of one or more machine events may be obtained from data sources outside or remote from the machine 102 and/or the machine component 104, e.g., from servers in a base station associated with the machine 102 and/or the machine component 104.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method for severity characterization of machine events, comprising:
receiving, at a processor, a plurality of inputs corresponding to measurements from a plurality of accelerometers placed on a machine component based upon a geometry of the machine component;
determining, at the processor, a displacement time series based upon the plurality of inputs;
comparing, at the processor, the displacement time series with coordinate locations of a plurality of corners of the machine component; and
characterizing, at the processor, severity of a machine event for the machine component, based upon said comparing.

2. The method of claim 1, wherein the receiving includes receiving synchronously exactly four inputs from four accelerometers placed on the machine component.

3. The method of claim 1, wherein the characterizing comprises:
determining, at the processor, relative displacements of the plurality of corners where the plurality of accelerometers are placed; and
determining, at the processor, at least one of warpage, shearing, bending, and a jerk associated with the machine component based upon said relative displacements.

4. The method of claim 3, wherein the determining the warpage comprises:
determining two or more triangles corresponding to a first pair of opposite corners;
calculating a first angle between said two or more triangles;
determining additional two or more triangles corresponding to a second pair of opposite corners;
calculating a second angle between said additional two or more triangles; and
determining said warpage by determining a maximum of the first and the second angles.

5. The method of claim 3, wherein the determining the skew comprises:
for a quadrangle in the displacement time series, calculating a minimum angle between two lines joining opposite mid-sides of the quadrangle, and
for a triangle in the displacement time series, calculating a minimum angle between a vector from between each corner to an opposite mid side and another vector from between two adjacent mid sides at each corner of the triangle.

6. The method of claim 3, wherein the determining the bending includes calculating a degree to which a curved line or a curved surface of the machine component deviates from a time-weighted averaged shape thereof, respectively.

7. The method of claim 3, wherein the determining the jerk includes:
determining an acceleration at a center of gravity of the machine component;
determining a maximum acceleration at a given distance from the center of gravity based upon the acceleration at the center of gravity; and
calculating a derivative of the maximum acceleration to obtain the jerk at the given distance from the center of gravity.

8. The method of claim 1, wherein the receiving includes receiving, at the processor, the plurality of inputs after removal of drift and after conversion to digital form by an analog to digital converter (ADC) operatively coupled to the processor, and receiving, at the processor, the plurality of inputs after filtering by a filter operatively coupled to the processor; and
wherein the determining includes performing, at the processor, a double integration of the plurality of inputs corresponding to the measurements from the plurality of accelerometers to obtain the displacement time series, after the drift has been removed.

9. The method of claim 1, wherein the plurality of corners of the machine components are chosen such that a history of one or more machine events at the plurality of corners is known.

10. The method of claim 1, wherein the machine component has a square or a rectangular shape and the plurality of accelerometers are placed on corners of said square or rectangular shape.

11. A system for severity characterization of machine events, comprising:
a plurality of accelerometers on a machine, said plurality of accelerometers being placed on a machine component based upon a geometry of the machine component; and
a processor operatively coupled to the plurality of accelerometers and configured to:
obtain measurements from the plurality of accelerometers, and
characterize severity of a machine event based upon the obtained measurements.

12. The system of claim 11, wherein the plurality of accelerometers includes four accelerometers placed on four respective corners of the machine component.

13. The system of claim 11 further comprising:
an analog to digital converter (ADC) having an input operatively coupled to the plurality of accelerometers and an output coupled to the processor;
a filter coupled to the plurality of accelerometers having an output coupled to the processor or the ADC; and
a memory coupled to the processor configured to store the characterized severity.

14. A machine comprising the system of claim 11.

15. The system of claim 11, wherein the plurality of accelerometers are removably attached to the machine component.

16. The system of claim 11 further comprising an electronic controller module including the processor.

17. A computer readable medium storing computer executable instructions thereupon for severity characterization of machine events, the instructions when executed by a processor cause the processor to:
receive a plurality of inputs corresponding to measurements from a plurality of accelerometers placed on a machine component;
determine a displacement time series based upon the plurality of inputs;
compare the displacement time series with coordinate locations of a plurality of corners of the machine component; and
characterize severity of a machine event for the machine component, based upon said comparing.

18. The computer readable medium of claim 17, wherein the processor is caused to receive the plurality of inputs by receiving synchronously at least four inputs from exactly four accelerometers placed on the machine component based upon a geometry of the machine component.

19. The computer readable medium of claim 17, wherein the processor is caused to characterize the severity by:
determining relative displacements of the plurality of corners where the plurality of accelerometers are placed; and
determining at least one of warpage, shearing, bending, and jerk of the machine component based upon said relative displacements.

20. The computer readable medium of claim 17, wherein the processor is caused to determine the displacement time series by performing a double integration of the plurality of inputs corresponding to the measurements from the plurality of accelerometers to obtain the displacement time series.
